(19) United States
(12) Patent Application Publication
(10) Pub. No.: US 2024/0406898 A1
(43) Pub. Date: Dec. 5, 2024

(54) PRIORITY-DEPENDENT TRANSMISSION OF SIDELINK SYNCHRONIZATION SIGNALS

(71) Applicant: Nokia Technologies Oy, Espoo (FI)

(72) Inventors: Konstantinos MANOLAKIS, Munich (DE); Faranaz SABOURI-SICHANI, Aalborg (DK); Jun TAN, Glenview, IL (US)

(21) Appl. No.: 18/699,522

(22) PCT Filed: Oct. 4, 2022
(86) PCT No.: PCT/EP2022/077496

§ 371 Date: Apr. 8, 2024

Related U.S. Application Data
(60) Provisional application No. 63/253,808, filed on Oct. 8, 2021.

(51) Int. Cl. H04W 56/00

(52) U.S. Cl. CPC H04W 56/002

(57) ABSTRACT

An out of coverage (OoC) user equipment (UE), of a wireless communications system, includes memory storing computer-executable instructions; and a processor configured to execute the computer-executable instructions, wherein the computer-executable instructions include receiving, at the OoC UE, first sidelink (SL) synchronization signaling from each of one or more neighboring UEs from among a plurality of neighboring UEs; and determining, by the OoC UE, whether to transmit a second SL synchronization signaling, based on the received first SL synchronization signaling, wherein the determining includes, generating at least one adjusted transmission determination value by adjusting at least one of, a synchronization transmission threshold, or signal powers of the one or more neighboring UEs, and determining whether to transmit the second SL synchronization signaling based on the adjusted transmission determination value.

### TECHNICAL FIELD

One or more example embodiments relate generally to wireless communications and, more specifically, to facilitating positioning in Third Generation Partnership Project (3GPP) Fifth Generation (5G) New Radio (NR) networks.

### BACKGROUND

Fifth generation (5G) wireless communications networks are the next generation of mobile communications networks. Standards for 5G communications networks are currently being developed by the Third Generation Partnership Project (3GPP). These standards are known as 3GPP New Radio (NR) standards. One area of development in 3GPP New Radio (NR) is sidelink (SL) technology which may enable, for example, advanced vehicle-to-anything (V2X) communication.

### SUMMARY

According to at least some example embodiments, a first user equipment (UE), of a wireless communications system includes memory storing computer-executable instructions; and a processor configured to execute the computer-executable instructions, wherein the computer-executable instructions include receiving, at the first UE, first sidelink (SL) synchronization signaling from each of one or more neighboring UEs from among a plurality of neighboring UEs; and determining, by the first UE, whether to transmit a second SL synchronization signaling, based on the received first SL synchronization signaling, wherein the determining includes, generating at least one adjusted transmission determination value by adjusting at least one of, a synchronization transmission threshold, or signal powers of the one or more neighboring UEs, and determining whether to transmit the second SL synchronization signaling based on the adjusted transmission determination value.

The computer-executable instructions may include determining a priority of the first UE.

For each of the one or more neighboring UEs, the first SL synchronization signaling received from the neighboring UE may include a SL synchronization signal block (S-SSB).

The generating of the at least one adjusted transmission determination value may include determining, based on the determined priority of the first UE, an offset value; and adjusting the synchronization transmission threshold by adding the determined offset value to the synchronization transmission threshold, wherein at least one adjusted transmission determination value includes the adjusted synchronization transmission threshold.

The generating of the at least one adjusted transmission determination value may include determining, based on the priority of the first UE, a multiplier value; and adjusting the synchronization transmission threshold by multiplying the synchronization transmission threshold by the determined multiplier value, wherein at least one adjusted transmission determination value includes the adjusted synchronization transmission threshold.

The computer-executable instructions may further include determining the signal powers of the one or more neighboring UEs based on the first SL synchronization signaling.

For each of the one or more neighboring UEs, the first SL synchronization signaling received from the neighboring UE may include an SL synchronization signal block (S-SSB), and the determining of the signal powers of the one or more neighboring UEs may include, for each neighboring UE among the one or more neighboring UEs, measuring an SL reference signal received power (S-RSRP) of the UE based on the S-SSB received from the neighboring UE.

The generating of the at least one adjusted transmission determination value may include determining priorities of the one or more neighboring UEs; and for each neighboring UE from among the one or more neighboring UEs, determining an offset value of the neighboring UE based on the determined priority of the neighboring UE, and adjusting the determined signal power of the neighboring UE by adding the determined offset value of the neighboring UE to the determined signal power of the neighboring UE, wherein the at least one adjusted transmission determination value includes the adjusted determined signal power of each UE from among the one or more neighboring UEs.

The generating of the at least one adjusted transmission determination value may include determining priorities of the one or more neighboring UEs; and for each neighboring UE from among the one or more neighboring UEs, determining a multiplier value of the neighboring UE based on the determined priority of the neighboring UE, and adjusting the determined signal power of the neighboring UE by multiplying the determined signal power of the neighboring UE by the determined multiplier value of the neighboring UE, wherein the at least one adjusted transmission determination value includes the adjusted determined signal power of each UE from among the one or more neighboring UEs.

The first UE may be an out of coverage (OoC) UE.

The first UE may be an in coverage (InC) UE.

According to at least some example embodiments, a method of operating a first user equipment (UE) of a wireless communications system includes receiving, at the first UE, first sidelink (SL) synchronization signaling from each of one or more neighboring UEs from among a plurality of neighboring UEs; and determining, by the first UE, whether to transmit a second SL synchronization signaling, based on the received first SL synchronization signaling, wherein the determining includes, generating at least one adjusted transmission determination value by adjusting at least one of, a synchronization transmission threshold, or signal powers of the one or more neighboring UEs, and determining whether to transmit the second SL synchronization signaling based on the adjusted transmission determination value.

The method may further include determining a priority of the first UE.

For each of the one or more neighboring UEs, the first SL synchronization signaling received from the neighboring UE may include a SL synchronization signal block (S-SSB).

The generating of the at least one adjusted transmission determination value may include determining, based on the determined priority of the first UE, an offset value; and adjusting the synchronization transmission threshold by adding the determined offset value to the synchronization transmission threshold, wherein at least one adjusted transmission determination value includes the adjusted synchronization transmission threshold.

The generating of the at least one adjusted transmission determination value includes determining, based on the priority of the first UE, a multiplier value; and adjusting the synchronization transmission threshold by multiplying the synchronization transmission threshold by the determined multiplier value, wherein at least one adjusted transmission determination value includes the adjusted synchronization transmission threshold.

The method may further include determining the signal powers of the one or more neighboring UEs based on the first SL synchronization signaling.

For each of the one or more neighboring UEs, the first SL synchronization signaling received from the neighboring UE may include an SL synchronization signal block (S-SSB), and the determining of the signal powers of the one or more neighboring UEs may include, for each neighboring UE among the one or more neighboring UEs, measuring an SL reference signal received power (S-RSRP) of the UE based on the S-SSB received from the neighboring UE.

The generating of the at least one adjusted transmission determination value may include determining priorities of the one or more neighboring UEs; and for each neighboring UE from among the one or more neighboring UEs, determining an offset value of the neighboring UE based on the determined priority of the neighboring UE, and adjusting the determined signal power of the neighboring UE by adding the determined offset value of the neighboring UE to the determined signal power of the neighboring UE, wherein the at least one adjusted transmission determination value includes the adjusted determined signal power of each UE from among the one or more neighboring UEs.

Wherein the generating of the at least one adjusted transmission determination value includes determining priorities of the one or more neighboring UEs; and for each neighboring UE from among the one or more neighboring UEs, determining a multiplier value of the neighboring UE based on the determined priority of the neighboring UE, and adjusting the determined signal power of the neighboring UE by multiplying the determined signal power of the neighboring UE by the determined multiplier value of the neighboring UE, wherein the at least one adjusted transmission determination value includes the adjusted determined signal power of each UE from among the one or more neighboring UEs.

The first UE may be an out of coverage (OoC) UE.

The first UE may be an in coverage (InC) UE.

According to at least some example embodiments, an out of coverage (OoC) user equipment (UE), of a wireless communications system, includes receiving means for receiving, at the first UE, first sidelink (SL) synchronization signaling from each of one or more neighboring UEs from among a plurality of neighboring UEs; and first determining means for determining, by the first UE, whether to transmit a second SL synchronization signaling, based on the received first SL synchronization signaling, wherein the first determining includes generating means for generating at least one adjusted transmission determination value by adjusting at least one of a synchronization transmission threshold, or signal powers of the one or more neighboring UEs, and second determining means for determining whether to transmit the second SL synchronization signaling based on the adjusted transmission determination value.

The first UE may be an out of coverage (OoC) UE.

The first UE may be an in coverage (InC) UE.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a diagram illustrating a portion of an example Generation Partnership Project (3GPP) Fifth Generation (5G) new radio (NR) sidelink (SL) deployment.

FIG. 2 is a diagram illustrating a portion of a wireless communications system according to at least some example embodiments.

FIG. 3 illustrates a network element according to at least some example embodiments.

FIG. 4 is flowchart illustrating an example method of deciding when a UE transmits NR SL synchronization signals.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

### 1. Overview of New Radio (NR) Sidelink (SL) Synchronization

In 3GPPThird Generation Partnership Project (3GPP) Release 16 (Rel-16), New Radio (NR) sidelink (SL) has been developed to enable advanced vehicle-to-anything (V2X) communication. In comparison with LTE SL (Rel.14), which only supports broadcast transmission, NR SL also supports unicast and groupcast, enabling thus a broader and more advanced set of V2X use cases. Moreover, NR SL provides higher reliability, lower latency, and higher throughout than LTE SL. The work item 5G_V2X_NRSL (i.e., 3GPP technical specification group (TSG) RAN meeting contribution document (TDoc) RP-190766) was destined as 3GPP V2X phase 3 targeted to support advanced V2X services beyond services supported in LTE Rel-15 V2X and approved in RAN #83 with the following objective related to a mechanism for SL synchronization:
Sidelink synchronization mechanism as per the study outcome [RAN1, RAN2]
   Procedures selecting synchronization reference
   S-SSB and procedures to transmit and receive it, including when global navigation satellite system (GNSS) and gNB/eNB are unavailable
   Use of RS for sidelink synchronization if specification impact is identified

In terms of synchronization, it is expected that all SL UEs can derive and follow a global timing reference if an eNB/gNB or GNSS signal is available. If there is no eNB or gNB or GNSS signal, then UEs need to align their timing references with each other. Even with the deployment of eNBs/gNBs, there could be out-of-coverage UEs whose signals from eNBs/gNBs are blocked or shadowed, or even UEs with poor or no GNSS coverage. To achieve all UEs following the same timing reference, SL UEs transmit sidelink synchronization signals (SLSS), so that those UEs can serve as a potential synchronization source for other SL UEs, even if not necessarily involved in active sidelink data transmission. On the other hand, a UE may not transmit synchronization signals, even though this UE may be involved in sidelink transmissions. In other words, sidelink synchronization and sidelink transmissions are decoupled procedures in such a decentralized manner.

In Rel-16, sidelink synchronization signals (SLSS) have been already defined, including sidelink primary and secondary synchronization signal (sidelink primary synchronization signal (S-PSS) and sidelink secondary synchronization signal (S-SSS)) and their structure within the Sidelink Synchronization Signal Block (S-SSB), as well as the way to derive the corresponding user ID, the physical sidelink broadcast channel (PSBCH) content, and the synchronization procedure. Further enhancement can be introduced in the 3GPP Release 17 (Rel-17) NR Sidelink enhancements (NR_SL_enh, see 3GPP TSG RAN TDoc RP-201516).

Though SL synchronization procedure has not been explicitly mentioned in the Rel-17 work item description (WID), it is a fundamental procedure/technology that has a direct impact on the achievable performance of sidelink communication, e.g. on reliability. Thus, there is continuous development and technical evolvement on sidelink synchronization procedure in Rel-17 and beyond.

Sidelink UEs needs to synchronize to the network, GNSS or other SL UEs, in order to obtain a time and frequency reference and receive system information. Sidelink UEs receive system information when synchronizing directly with a gNB/eNB or indirectly via another UE, by decoding the PSBCH (included in the S-SSB). A sidelink UE may transmit synchronization signal to extend the coverage by serving as a synchronization source for other out of coverage UEs and also providing system information.

According to 3GPP (see 3GPP technical specification (TS) 38.331, section 5.8.5.2), transmission of synchronization signals is only initiated if certain conditions are met:

A UE capable of NR sidelink communication and SLSS/PSBCH transmission shall, when transmitting NR sidelink communication, and if the conditions for NR sidelink communication operation are met and when the following conditions are met:
1> if in coverage on the frequency used for NR sidelink communication, as defined in TS 38.304 [20]; and has selected GNSS or the cell as synchronization reference as defined in 5.8.6.3; or
1> if out of coverage on the frequency used for NR sidelink communication, and the frequency used to transmit NR sidelink communication is included in sl-FreqInfoToAddModList in sl-ConfigDedicatedNR within RRCReconfiguration message or included in sl-FreqInfoList within SIB12; and has selected GNSS or the cell as synchronization reference as defined in 5.8.6.3:
   2> if in RRC_CONNECTED; and if networkControlledSyncTx is configured and set to on: or
   2> if networkControlledSyncTx is not configured; and for the concerned frequency syncTxThreshIC is configured; and the reference signal received power (RSRP) measurement of the reference cell, selected as defined in 5.8.6.3, for NR sidelink communication transmission is below the value of syncTxThreshIC:
      3> transmit sidelink SSB on the frequency used for NR sidelink communication in accordance with 5.8.5.3 and TS 38.211 [16], including the transmission of SLSS as specified in 5.8.5.3 and transmission of MasterInformationBlockSidelink as specified in 5.8.9.4.3;
1> else:
   2> for the frequency used for NR sidelink communication, if syncTxThreshOoC is included in SL-PreconfigurationNR; and the UE is not directly synchronized to GNSS, and the UE has no selected SyncRef UE or the sidelink reference signal received power (S-RSRP) measurement result of the selected SyncRef UE is below the value of syncTxThreshOoC; or
   2> for the frequency used for NR sidelink communication, if the UE selects GNSS as the synchronization reference source:
      3> transmit sidelink synchronization signal block (S-SSB) on the frequency used for NR sidelink communication in accordance with TS 38.211 [16], including the transmission of SLSS as specified in 5.8.5.3 and transmission of MasterInformationBlockSidelink as specified in 5.8.9.4.3.

From a UE point of view, an OoC UE looks for another UE(s) providing synchronization reference. For this search it uses the SLSS IDs as measurement parameters. Such a UE, if found, is called SyncRef UE. “Translating” the above given 3GPP specification for out-of-coverage UE practically means that:
If configured accordingly (syncTxThreshOoC is included in SL-PreconfigurationNR), an out-of-coverage UE will transmit S-SSB if:
   not directly synchronized to GNSS or
   not having selected a syncRefUE or
   having selected a SyncRefUE from which it measures an S-RSRP below the preconfigured threshold syncTxThreshOoC.
Otherwise the UE does not transmit itself S-SSB.
It is also noted that an OoC UE directly synchronized to GNSS will always transmit S-SSB.

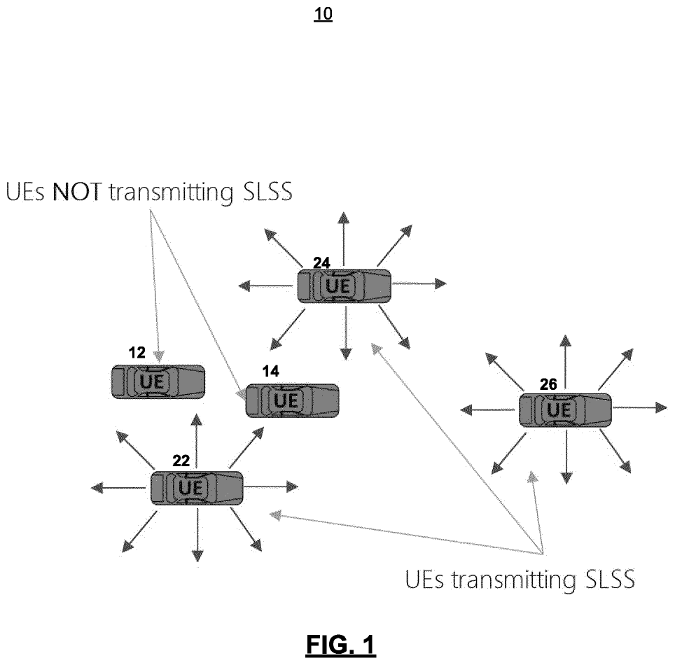

The intention behind the specified conditions is that OoC UEs extend sidelink synchronization coverage when needed by transmitting S-SSB including SLSS. FIG. 1 is a diagram illustrating a portion of an example Generation Partnership Project (3GPP) Fifth Generation (5G) new radio (NR) sidelink (SL) deployment. FIG. 1 shows an example of an out of coverage (OoC) scenario where some UEs do not transmit S-SSB, because other nearby UEs already transmit S-SSB. In the example illustrated in FIG. 1, UEs 12 and 14 do not transmit S-SSB while UEs 22, 24 and 26 each transmit S-SSB. Though not illustrated, at least one of UEs 22, 24 and 26 is within the coverage area of a gNB. Considering, for example, a reference UE, if the reference UE measures an S-RSRP from its SyncRefUE and the measured S-RSRP is above the predefined threshold syncTxThreshOoC, the reference UE will not transmit S-RSRP. In this way, especially the UEs close to outer boundaries of a “synchronization cluster” will be the most likely UEs to transmit S-SSB and extend coverage. UEs with many other UEs around them typically will not transmit S-SSB and, in this way, will avoid potentially creating unnecessary interference.

Synchronization sources may be, for example, GNSS, gNB, eNB, another NR UE. Each of these example synchronization sources has an associated priority specified in TR 38.885 and shown in Table 1, below. Whether GNSS- or gNB/eNB-based synchronization is used is configured (e.g., pre-configured). Conventionally, these priorities are generally used only as part of a UE's procedure in selecting its own synchronization source.

TABLE 1

| Priority | GNSS-based | gNB/eNB-based |
|---|---|---|
| level | synchronization | synchronization |
| P0 | GNSS | gNB/eNB |
| P1 | All UEs directly synchronized | All UEs directly synchronized |
| | to GNSS | to gNB/eNB |
| P2 | All UEs indirectly | All UEs indirectly |
| | synchronized to GNSS | synchronized to gNB/eNB |
| P3 | Any other UE | GNSS |
| P4 | N/A | All UEs directly synchronized |
| | | to GNSS |
| P5 | N/A | All UEs indirectly |
| | | synchronized to GNSS |
| P6 | N/A | Any other UE |

2. Issues with NR SL UE Synchronization

As part of the decision of an out of coverage (OoC) UE (i.e., a UE outside the geographical coverage area of a base station or gNB) to select its synchronization reference (e.g., gNB/eNB, GNSS, SyncRef UE), clear priorities have been specified in 3GPP TS 38.331, section 5.8.6.2 and Table 1 above. Following the specified rule, if an OoC reference UE detects SLSS from multiple SL UEs, which may potentially serve as a synchronization source for that reference UE, the reference UE selects its SyncRef UE based on these priorities and afterwards uses SyncRef UE to derive its own time reference and obtain broadcast information by decoding and reading the PSBCH.

However, priorities are in the current standard not being considered for deciding on whether a UE may act as synchronization source by transmitting S-SSB. As explained in Section 2, according to the current specification, transmission of S-SSB and the SLSS therein depends only on the UE's configuration and the S-RSRP measurements. A consequence of only considering S-RSRP measurements is that in an OoC scenario, it may happen that UEs which have a higher priority in serving as a synchronization source (SyncRef UE for other UEs) do not transmit S-SSB, but instead other UEs with lower priority transmit S-SSB as triggered by their S-RSRP measurements. However, higher priorities are typically associated with sources of higher quality and reliability of synchronization (accuracy, stability) of the reference they provide. Therefore, this situation may result that the lower priority UEs transmitting S-SSB will provide an overall poorer synchronization coverage in an OoC scenario.

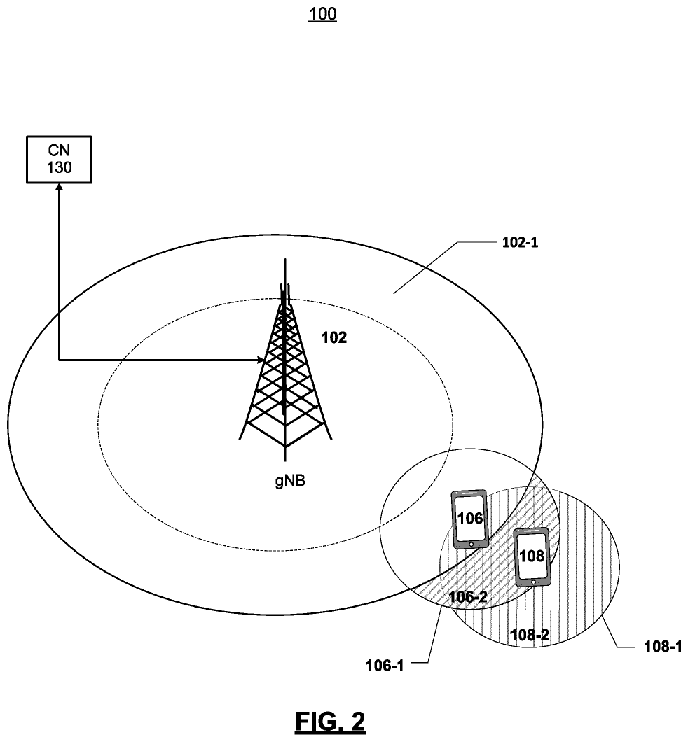

Examples of an architecture of a wireless communications network and a structure of a network element, according to at least some example embodiments, will now be discussed below with reference to FIGS. 1 and 2.

### 3. Example Architecture of a Wireless Communications System and an Example Structure of a Network Element Thereof.

FIG. 2 illustrates a simplified diagram of a portion of a 3rd Generation Partnership Project (3GPP) New Radio (NR) access deployment for explaining example embodiments in more detail.

Referring to FIG. 2, wireless communications system 100 is an example of a 3GPP NR radio access deployment and includes a gNB 102 having a geographical coverage area 102-1. Though not illustrated, the gNB 102 may have a plurality of transmission and reception points (TRPs). Each TRP may be, for example, a remote radio head (RRH) or remote radio unit (RRU) including at least, for example, a radio frequency (RF) antenna (or antennas) or antenna panels, and a radio transceiver, for transmitting and receiving data. In this regard, the gNB 102 provides cellular resources for user equipment (UEs) (e.g., first UE 106) within a geographical coverage area (i.e., gNB coverage area 102-1), for example, via the TRPs. In some cases, baseband processing may be divided between the TRPs and gNB 102 in a 5th Generation (5G) cell. Alternatively, the baseband processing may be performed at the gNB 102. The gNB 102 is configured to communicate with UEs within gNB coverage area 102-1 via the TRPs of the gNB 102, and each TRP of the gNB 102 can communicate with UEs via one or more transmit (TX)/receive (RX) beam pairs. Further, the gNB 102 communicates with the core network (CN) 130, which is referred to as the New Core or 5G core (5GC) in 3GPP NR. For the sake of clarity of example embodiments, communications between the gNB 102 and UEs within the gNB coverage area 102-1 will be discussed, primarily, without reference to the TRPs of the gNB 102. However, it will be understood that communication between the gNB 102 and UEs within the gNB coverage area 102-1 (i.e., UL and DL transmissions) is generally accomplished using signals sent via the TRPs of the gNB 102.

As is illustrated in FIG. 2, wireless communications system 100 supports sidelink (SL) communications. NR sidelink (SL) allows a UE to communicate with other nearby UE(s) via direct/SL communication (e.g., without an intervening gNB or TRP). Accordingly, NR SL allows a UE that is within the geographical coverage area of gNB to essentially extend the coverage area of the gNB to UEs that are outside the geographical coverage area of the gNB. In the present specification, UEs within the geographical coverage area of a gNB may be referred to as in coverage (or “InC”) UEs and UEs outside the geographical coverage area of the gNB may be referred to as an out of coverage (or “OoC”) UEs. For example, in the example illustrated in FIG. 2, the first UE 106 is within the geographical coverage area 102-1 of the gNB 102, and thus, is an InC UE while the second UE 108 is outside the geographical coverage area 102-1 of the gNB 102, and thus, is an OoC UE. Further, as is also illustrated in FIG. 2, the first UE 106 has a geographical coverage area with respect to SL communications, first UE coverage area 106-1. Accordingly, the portion of the first UE coverage area 106-1 that extends beyond gNB coverage area 102-1 is a first extended coverage area 106-2 provided by the first UE 106, within which the first UE 106 may support SL communications for other UEs. In the example illustrated in FIG. 2, the second UE 108 is within the extended coverage area 106-2, and thus, the first UE 106 is capable of providing SL support to the second UE 108. Further, as is also illustrated in FIG. 2, the second UE 108 has a geographical coverage area with respect to SL communications, second UE coverage area 108-1. Accordingly, the portion of the second UE coverage area 108-1 that extends beyond first UE coverage area 106-1 is a second extended coverage area 108-2 provided by the second UE 108, within which the first UE 106 may support SL communications for other UEs.

Although only a single two UEs (i.e., first UE 106 and second UE 108) are shown in FIG. 2, the gNB 102 may provide communication services to a relatively large number of UEs within the gNB coverage area 102-1.

Example functionality and operation of the first and second UEs 106 and 108 will be discussed in more detail below. Examples of devices which may embody one or both of the first and second UEs 106 and 108 include, but are not limited to, a mobile device, a tablet, a laptop computer, a wearable device, an Internet of Things (IoT) device, a desktop computer and/or any other type of stationary or portable device capable of operating according to the 5G NR communication standard, and/or other wireless communication standard.

According to at least some example embodiments, the wireless communications system 100 is not limited to the elements illustrated in FIG. 2 and the wireless communications system 100 may include numbers of constituent elements different than those shown in FIG. 2. For example, the wireless communications system 100 may include any number of UE devices, any number of gNBs, etc.

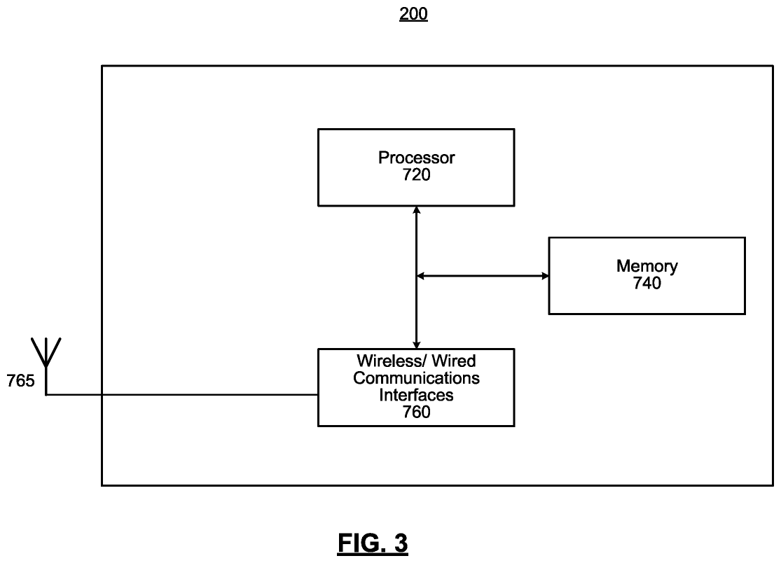

Additionally, though not illustrated, the CN 130 may include a number of 5GC network elements. For example, the gNB 102 may be connected to a location management function (LMF), an access and mobility management function (AMF) element and/or a session management function (SMF) element. Additionally, though not illustrated, the wireless communications system 100 may further include long-term evolution (LTE) network elements that are connected to the gNB 102. Examples of such LTE elements include, but are not limited to, LTE radio access technology (RAT) network elements (e.g., evolved universal mobile telecommunications system (UMTS) terrestrial radio access network (E-UTRAN) network elements) such as evolved node Bs (eNBs), and LTE core network elements (e.g., evolved packet core (EPC) network elements) such as mobility management entities (MMEs). An example structure which may be used to embody one or more radio network elements (e.g., gNBs, UEs, etc.) of the wireless communications system 100 will now be discussed below with respect to FIG. 3.

FIG. 3 illustrates an example embodiment of a network element. Referring to FIG. 3, a network element 200 includes: a memory 740, a processor 720, and various communications interfaces 760 connected to each other; and one or more antennas or antenna panels 765 connected to the various communications interfaces 760. The various interfaces 760 and the antenna 765 may constitute a transceiver for transmitting/receiving data to/from a UE, a gNB, a CN node, a CN element, and/or another radio network element via one or more of a plurality of wireless beams. According to at least some example embodiments, in addition to, or alternatively, instead of, including interfaces for supporting wireless communications, various interfaces 760 may include interfaces for supporting wired communications.

As will be appreciated, depending on the implementation of the network element 200, the network element 200 may include many more components than those shown in FIG. 3 for providing the functionalities of the particular element of the wireless communications system 100 being embodied by the network element 200 (e.g., functionalities of a UE, a CN element, a gNB, etc. in accordance with one or more example embodiments). However, it is not necessary that all of these generally conventional components be shown in order to disclose the illustrative example embodiment.

The memory 740 may be a computer readable storage medium that generally includes a random access memory (RAM), read only memory (ROM), and/or a permanent mass storage device, such as a disk drive. The memory 740 also stores an operating system and any other routines/modules/applications for providing the functionalities of the particular element of the wireless communications system 100 being embodied by the network element 200 (e.g., functionalities of a UE, a CN element and/or node, a gNB, etc. in accordance with one or more example embodiments) to be executed by the processor 720. These software components may also be loaded from a separate computer readable storage medium into the memory 740 using a drive mechanism (not shown). Such separate computer readable storage medium may include a disc, tape, DVD/CD-ROM drive, memory card, or other like computer readable storage medium (not shown). In some example embodiments, software components may be loaded into the memory 740 via one of the various interfaces 760, rather than via a computer readable storage medium. According to at least some example embodiments, the memory 740 may store computer-executable instructions corresponding to any or all steps discussed with reference to FIGS. 1-4.

The processor 720 may be configured to carry out instructions of a computer program by performing the arithmetical, logical, and input/output operations of the system. Instructions may be provided to the processor 720 by the memory 740.

The various interfaces 760 may include components that interface the processor 720 with the one or more antennas 765, or other input/output components. As will be understood, the various interfaces 760 and programs stored in the memory 740 to set forth the special purpose functionalities of the network element 200 will vary depending on the particular element of the wireless communications system 100 being embodied by the network element 200.

The various interfaces 760 may also include one or more user input devices (e.g., a keyboard, a keypad, a mouse, or the like) and user output devices (e.g., a display, a speaker, or the like).

Example methods for facilitating priority-dependent transmission of sidelink synchronization signals will now be discussed below with reference to FIGS. 1-4.

### 4. Example Methods for Facilitating Priority-Dependent Transmission of Sidelink Synchronization Signaling

According to at least some example embodiments, the existing rule, based on which S-SSB transmission is activated by OoC UEs, is extended. For example, the existing criteria for a UE to transmit the S-SSB is augmented by adding one or more criteria to the evaluation on whether an S-SSB should be transmitted from the UE. Accordingly to at least some example embodiments, the S-SSB may include SL synchronizations signals (SLSS), i.e., an SL-primary synchronization signal (S-PSS) and an SL-secondary synchronization signal (S-SSS). The term SL synchronization signaling, as used in the present specification, refers to SL-related synchronization signals (e.g., S-SSB, SLSS, S-PSS and/or S-SSS). Existing parameters as well as the proposed added parameters are listed below.

Already in the standard:
1) If the UE is synchronized to GNSS directly transmit S-SSB.
2) If the UE is not synchronized to GNSS directly;
   a) Determine if syncRef UE is identified
   b) Decide to transmit S-SSB based on S-RSRP level of the SyncRefUE

Proposed criteria to further enhance the decision:
1) According to at least some example embodiments, the network (e.g., the CN 130) configures or, alternatively, pre-configures an offset, (called, e.g., PriorityOffset) or a weighting factor (called, e.g., PriorityMultiplier), based on the synchronization priority level of the UE (cf. Section 2), which can be either applied to the received S-RSRPs from S-SSBs transmitted from other UEs and/or can be applied to the syncTxThreshOoC. The offset or weighting factor can be added as new information element in SL-PreconfigurationNR;
   a) Whether to configure an offset or a weighting factor may be, for example, a network decision.
   b) The parameters may be, for example, preconfigured (e.g. specified in the specification), and dynamically enabled/disabled or changed depending on a network decision.
   c) According to at least some example embodiments, in a configuration or, alternatively, pre-configuration of parameters, a set of values for PriorityOffset and/or PriorityMultiplier may be provided for each of the supported UE synchronization priorities listed in Table 1.
2) According to at least some example embodiments, a deciding UE, which may be, for example, an OoC UE (e.g., second UE 108) that is deciding whether or not to transmit S-SSB, may apply the offset or weighting factor using either of the two below embodiments (i.e., Example A and Example B), or a combination of both. According to at least some example embodiments, which alternative to use may be determined by the network configuration. The defined PriorityOffset or PriorityMultiplier may be different depending on which of below methods is chosen/configured.
   a) Example A: The synchronization priority level of the deciding UE (e.g., second UE 108), itself, may be used to apply the offset (additive) or weighting factor (multiplicative) to the threshold, syncTxThreshOoC.
      i) For example, assume the deciding UE (e.g., second UE 108) measures a first S-RSRP, S-RSRP-1, and a second S-RSRP, S-RSRP-2, from two other UE's without knowing the priorities of the 2 other UEs. The deciding UE (e.g., second UE 108) knows its own priority and may apply the corresponding PriorityOffset or PriorityMultiplier to the syncTxThreshOoC before evaluating the first and second S-RSRPs S-RSRP-1 and S-RSRP-2, which may increase the probability that the deciding UE (e.g., second UE 108) decides to transmit, or continue transmitting, the S-SSB when the deciding UE's priority is high.
   b) Example B: The synchronization priorities of the UEs from which the deciding UE (e.g., second UE 108) receives S-SSBs and from which the deciding UE can measure and evaluate S-RSRPs. Here, UEs' synchronization priorities may be used to apply the corresponding PriorityOffset or PriorityMultiplier to each measured S-RSRP level
      i) For example, assume the deciding UE (e.g., the second UE 108) measures first and second S-RSRPs S-RSRP-1 and S-RSRP-2 from two other UE's and extracts information about their priorities. Knowing their priorities the deciding UE may apply the corresponding PriorityOffset or PriorityMultiplier to the measured first and second S-RSRPs S-RSRP-1 and S-RSRP-2 before evaluating the measured first and second S-RSRPs S-RSRP-1 and S-RSRP-2 against syncTxThreshOoC, which may increase the probability that the deciding UE (e.g., second UE 108) decides to transmit, or continue transmitting, the S-SSB when the deciding UE's priority is high.

A goal of both embodiments (i.e., Example A and Example B) with the UE applying PriorityOffset or PriorityMultiplier in a way to either adjust the syncTxThreshOoC and/or adjust the received S-RSRPs is that UEs with higher synchronization priority will be more likely to transmit S-SSB, and thus provide SL synchronization coverage, in comparison with UEs having lower synchronization priority. With such an arrangement, overall higher synchronization quality may be achieved.

According to at least some example embodiments, with Example B, the deciding UE receiving S-SSBs from neighboring UEs will need to extract the priority information of the neighboring UEs from the S-SSBs transmitted by the neighboring UEs. Thus, according to at least some example embodiments, the deciding UE is capable of decoding information included in the S-SSB and not only measuring an S-RSRP based on the S-SSB.

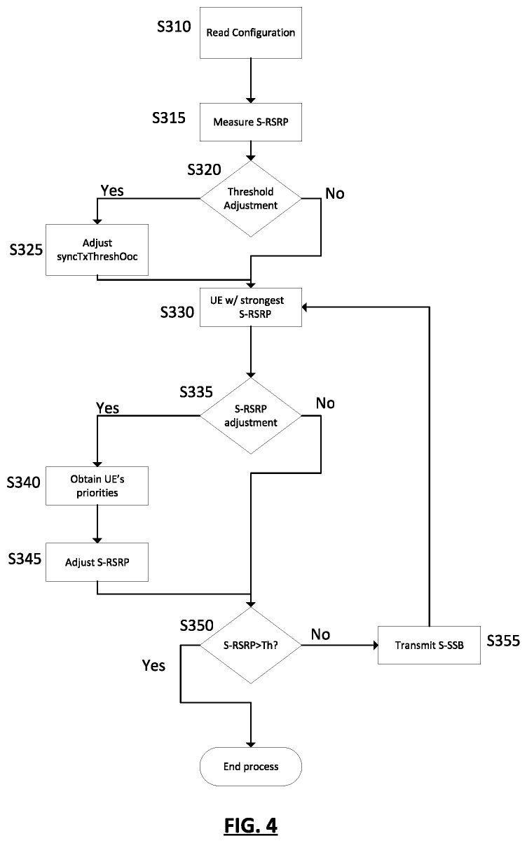

Example methods for facilitating priority-dependent transmission of SL synchronization signaling will now be discussed in greater detail below with reference to FIG. 4.

FIG. 4 will be explained, below, with reference to a scenario in which the second UE 108 is the deciding UE. As is illustrated in FIG. 2, the second UE 108 is an out of contact (OoC) UE with respect to the gNB coverage area 102-1. However, according to at least some example embodiments, the method illustrated in FIG. 4 may also be performed by an InC UE, such as first UE 106, acting as a deciding UE.

Referring to FIG. 4, in step S310, the second UE 108 reads the configuration stored in the second UE 108. For example, the configuration of the second UE 108 may have been set by a manufacturer of the second UE 108. As another example, the configuration of the second UE 108 may have been set based on signaling received at the second UE 108 from a CN network element (e.g., a gNB), for example, at a previous point in time when the second UE was within the coverage area of a gNB or base station (BS) of a wireless communications network (e.g., the gNB 102 of the wireless communications system 100).

Examples of information that may be included in the configuration stored in the second UE 108 include, but are not limited to, the original (i.e., unadjusted)synchronization threshold syncTxThreshOoC, the priority (e.g., priority value) of the second UE 108; a synchronization threshold adjustment mapping table mapping multiple potential priorities (e.g., priority values) of the second UE 108 to multiple corresponding potential values for an offset value (e.g., PriorityOffset) and/or multiplier value (e.g., PriorityMultiplier) that the second UE 108 is to apply to the synchronization threshold syncTxThreshOoC when performing a threshold adjustment operation (e.g., step S325); an offset value (e.g., PriorityOffset) and/or multiplier value (e.g., PriorityMultiplier), assigned to the second UE 108 by the network (e.g., the CN 130), that the second UE 108 is to apply to the synchronization threshold syncTxThreshOoC when performing a threshold adjustment operation (e.g., step S325) (i.e., the assigned offset and/or multiplier value may be provided in the configuration of the second UE 108, in which case the configuration may omit a table mapping multiple potential priority values of the second UE 108 to multiple corresponding potential values for an offset value and/or a multiplier value to be applied to the synchronization threshold); and a signal power adjusting mapping table mapping multiple potential priorities (e.g., priority values) of neighboring UEs to multiple corresponding potential values for an offset value (e.g., PriorityOffset) and/or multiplier value (e.g., PriorityMultiplier) that the second UE 108 is to apply to signal powers (e.g., SL-RSRPs) measured with respect to neighboring UEs when performing a signal power adjustment operation (e.g., step S345). Examples of information that may be included in the configuration stored in the second UE 108 further include, but are not limited to, an indication of whether or not the second UE 108 is to perform a threshold adjustment operation (e.g., step S325); an indication of whether the second UE 108 is to use multiplication by a multiplier value (e.g., PriorityMultiplier) or the addition of an offset value (e.g., PriorityOffset) to adjust the synchronization threshold syncTxThreshOoC when performing the threshold adjustment operation (e.g., step S325); and an indication of whether or not the second UE 108 is to perform a signal power adjustment operation (e.g., step S345); and an indication of whether the second UE 108 is to use multiplication by a multiplier value (e.g., PriorityMultiplier) or the addition of an offset value (e.g., PriorityOffset) to adjust the measured signal powers (e.g., S-RSRPs) of neighboring UEs when performing the signal power adjustment operation (e.g., step S345).

In step S315, the second UE 108 measures signal powers of one or more neighboring UEs. For example, according to at least some example embodiments, in step S315, the second UE 108 may measure an SL reference signal receive power (SL-RSRP) for one or more neighboring UEs. For example, the second UE 108 may receive SL synchronization signaling from one or more neighboring UEs. Neighboring UEs refers to, for example, UEs within the proximity of the second UE 108 such as the first UE 106. According to at least some example embodiments, the second UE 108 may measure one or more SL-RSRPs of the one or more neighboring UEs based on SL synchronization signaling received from the one or more neighboring UEs. For example, the SL synchronization signaling received from each of the one or more neighboring UEs may be an S-SSB including SLSS, and the second UE 108 may measure the SL-RSRPs of each of the one or more neighboring UEs based on the S-SSBs received from each of the one or more neighboring UEs.

In step S320, the second UE 108 may determine whether or not to perform a threshold adjustment operation. According to at least some example embodiments, the configuration of the second UE 108 read in step S310 specifies whether or not the second UE 108 is to perform the threshold adjustment operation. Accordingly, the second UE 108 may determine whether or not to perform the threshold adjustment operation in step S320 based on the configuration read in step S310.

If, in step S320, the second UE 108 determines to perform the threshold adjustment operation, the second UE 108 proceeds to step S325.

In step S325, the second UE 108 performs the threshold adjustment operation. For example, in step S325, the second UE 108 may adjust the synchronization threshold syncTxThreshOoC. For example, as is discussed above with respect to Example A, the second UE 108 may perform the threshold adjustment operation by adding an offset value PriorityOffset corresponding to the priority of the second UE 108 to the synchronization threshold syncTxThreshOoC or by multiplying the synchronization threshold syncTxThreshOoC by a multiplier value PriorityMultiplier corresponding to the priority of the second UE 108. As is discussed above, according to at least some example embodiments, the configuration stored in the second UE 108 and read in step S310 may specify whether the second UE 108 is to use addition of an offset value or multiplication by a multiplier value to adjust the synchronization threshold syncTxThreshOoC in step S325.

According to at least some example embodiments, after step S325, the second UE 108 proceeds to step S330.

Returning to step S320, if, in step S320, the second UE 108 determines not to perform the threshold adjustment operation, the second UE 108 proceeds to step S330.

In step S330, the second UE 108 determines which UE, from among the neighboring UEs for which the second UE 108 measured signal powers (e.g., S-RSRPs) in step S315, is associated with the highest measured signal power. According to at least some example embodiments, after step S330, the second UE 108 proceeds to step S335.

In step S335, the second UE 108 determines whether to perform a signal power adjustment operation. According to at least some example embodiments, the configuration of the second UE 108 read in step S310 specifies whether or not the second UE 108 is to perform the signal power adjustment operation. Accordingly, the second UE 108 may determine whether or not to perform the signal power adjustment operation in step S335 based on the configuration read in step S310.

If, in step S335, the second UE 108 determines to perform the signal power adjustment operation, the second UE 108 proceeds to step S340.

In step S340, the second UE 108 obtains priorities of one or more neighboring UEs (e.g., the one or more neighboring UEs for which the second UE 108 performed signal power measurements in step S315). For example, according to at least some example embodiments, each S-SSB that the second UE 108 used to perform S-RSRP measurements of the one or more neighboring UEs in step S315 may also include an indication of a priority of the neighboring UE to which the S-SSB corresponds. Accordingly, in step S340, the second UE 108 may obtain priorities of one or more neighboring UEs based on S-SSBs received at the second UE 108.

According to at least some example embodiments, after step S340, the second UE 108 proceeds to step S345.

In step S345, the second UE 108 performs the signal power adjustment operation. For example, in step S345, the second UE 108 may adjust the signal powers (e.g., S-RSRPs) measured by the second UE 108 in step S315. For example, using the first UE 106 as an example neighboring UE, as is discussed above with respect to Example B, the second UE 108 may perform the signal power adjustment operation by adding an offset value PriorityOffset corresponding to a priority of the first UE 106 (which was determined in step S340) to the signal power (e.g., S-RSRP) measured for the first UE 106 (e.g., in step S315) or by multiplying the signal power (e.g., S-RSRP) measured for the first UE 106 (e.g., in step S315) by a multiplier value PriorityMultiplier corresponding to the priority of the first UE 106. According to at least some example embodiments, the above-referenced operations described as being performed with respect to the first UE 106 may be performed by the second UE 108 for all neighboring UEs of the second UE 108 for which the second UE 108 measured a signal power in step S315. As is discussed above, according to at least some example embodiments, the configuration stored in the second UE 108 and read in step S310 may specify whether the second UE 108 is to use addition of an offset value or multiplication by a multiplier value to adjust the measured signal powers (e.g., S-RSRPs measured in step S315) in step S345, and the configuration may also include a signal power mapping table which the second UE 108 may search to look-up the offset value PriorityOffset and/or multiplier value PriorityMultiplier corresponding to the priority of each of the neighboring UEs.

According to at least some example embodiments, after step S345, the second UE 108 proceeds to step S350.

Returning to step S335, if, in step S335, the second UE 108 determines not to perform the signal power adjustment operation, the second UE 108 proceeds to step S350.

In step S350, the second UE 108 determines whether the second UE 108, itself, is to transmit SL synchronization signaling. According to at least some example embodiments, the second UE 108 determines whether to transmit SL synchronization signaling by comparing a strongest signal power value to a synchronization threshold value. According to at least some example embodiments, if the strongest signal power value exceeds the synchronization threshold value in step S350, then the process ends. Otherwise, if the strongest signal power value does not exceed the synchronization threshold value, the second UE 108 proceeds to step S355. In step S355, the second UE 108 begins (or continues) transmitting SL synchronization signaling (e.g., an S-SSB including SLSS).

If the second UE 108 determined to perform the threshold adjustment operation in step S320, then the synchronization threshold value used for the comparison in step S350 is the adjusted synchronization threshold value determined by the second UE 108 in step S325. Otherwise, the synchronization threshold value used for the comparison in step S350 is the original (i.e., unadjusted) synchronization threshold value. If the second UE 108 determined to perform the signal power adjustment operation in step S335, then the strongest signal power value used for the comparison in step S350 is the highest signal power value from among all the adjusted signal power values determined by the second UE 108 in step S345. Otherwise, the strongest signal power value used for the comparison in step S350 is the highest signal power from among the one or more measured signal powers measured by the second UE 108 in step S315. The adjusted synchronization threshold value determined by the second UE 108 in step S325 and adjusted signal power values determined by the second UE 108 in step S345 are each examples of an adjusted transmission determination value.

According to at least some example embodiments, steps S330-S355 are performed iteratively. Accordingly, the strongest signal power determined by the second UE 108 in step S330 is the strongest signal power from among adjusted signal powers when signal power adjustment (i.e., step S345) was performed during a previous iteration. Further, the strongest signal power determined by the second UE 108 in step S330 may be the strongest signal power from among measured (i.e., unadjusted) signal powers when signal power adjustment (i.e., step S345) was not performed during a previous iteration. Though not illustrated, while iteratively performing steps S330-S355, the second UE 108 may occasionally update the measured signal power values (e.g., S-RSRPs) of one or more neighboring UEs by re-measuring the signal powers of the one or more neighboring UEs.

According to at least some example embodiments, steps S340 and S345 are performed with respect to all neighboring UEs for which the second UE 108 measured a signal power (e.g., an S-RSRP) in step S315.

Alternatively, according to at least some example embodiments, steps S340 and S345 are performed only with respect neighboring UEs for which the second UE 108 measured a signal power (e.g., an S-RSRP) in step S315 that exceeds a first threshold value. Accordingly, neighboring UEs for which signal powers under the first threshold value were measured in step S315 are omitted from steps S340 and S345, and thus, step S350.

As yet another alternative, according to at least some example embodiments, the second UE 108 chooses the neighboring UE having the highest priority as the SyncRef UE of the second UE 108, and the signal power used by the second UE 108 for the comparison in step S350 is the measured signal power (e.g., S-RSRP) of the SyncRef UE.

With methods for facilitating priority-dependent transmission of SL synchronization signaling according to at least some example embodiments, transmission of S-SSB by a UE may not only depend on S-RSRP power measurements from the SyncRef UE, but may potentially also depend on measurements from a broader set of UEs, and, mainly, on the priorities of the UE (i.e., the deciding OoC UE) and the other UEs (i.e., the neighboring UEs) from which S-SSBs are received. In this way, SL synchronization coverage may be provided by the UEs with higher synchronization priorities, thus, resulting in more reliable SL synchronization.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided above to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing UE, base stations, eNBs, RRHs, gNBs, femto base stations, network controllers, computers, Central Units (CUs), ng-eNBs, other radio access or backhaul network elements, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, UEs, base stations, eNBs, RRHs, gNBs, femto base stations, network controllers, computers, central units (CUs), ng-eNBs, other radio access or backhaul network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A first user equipment (UE), of a wireless communications system, the UE comprising:
memory storing computer-executable instructions; and
a processor configured to execute the computer-executable instructions, wherein the computer-executable instructions include:
receiving, at the first UE, first sidelink (SL) synchronization signaling from each of one or more neighboring UEs from among a plurality of neighboring UEs; and
determining, by the first UE, whether to transmit a second SL synchronization signaling, based on the received first SL synchronization signaling,
wherein the determining includes,
generating at least one adjusted transmission determination value by adjusting at least one of,
a synchronization transmission threshold, or
signal powers of the one or more neighboring UEs, and
determining whether to transmit the second SL synchronization signaling based on the adjusted transmission determination value.

2. The first UE of claim 1, wherein the computer-executable instructions further include determining a priority of the first UE.

3. The first UE of claim 2, wherein, for each of the one or more neighboring UEs, the first SL synchronization signaling received from the neighboring UE includes a SL synchronization signal block (S-SSB).

4. The first UE of claim 2, wherein the generating of the at least one adjusted transmission determination value comprises:
determining, based on the determined priority of the first UE, an offset value; and
adjusting the synchronization transmission threshold by adding the determined offset value to the synchronization transmission threshold,
wherein at least one adjusted transmission determination value includes the adjusted synchronization transmission threshold.

5. The first UE of claim 2, wherein the generating of the at least one adjusted transmission determination value comprises:
determining, based on the priority of the first UE, a multiplier value; and
adjusting the synchronization transmission threshold by multiplying the synchronization transmission threshold by the determined multiplier value,
wherein at least one adjusted transmission determination value includes the adjusted synchronization transmission threshold.

6. The first UE of claim 1, wherein the computer-executable instructions further include determining the signal powers of the one or more neighboring UEs based on the first SL synchronization signaling.

7. The first UE of claim 6,
wherein, for each of the one or more neighboring UEs, the first SL synchronization signaling received from the neighboring UE includes an SL synchronization signal block (S-SSB), and
wherein, the determining of the signal powers of the one or more neighboring UEs includes, for each neighboring UE among the one or more neighboring UEs, measuring an SL reference signal received power (S-RSRP) of the UE based on the S-SSB received from the neighboring UE.

8. The first UE of claim 6, wherein the generating of the at least one adjusted transmission determination value comprises:
determining priorities of the one or more neighboring UEs; and
for each neighboring UE from among the one or more neighboring UEs,
determining an offset value of the neighboring UE based on the determined priority of the neighboring UE, and
adjusting the determined signal power of the neighboring UE by adding the determined offset value of the neighboring UE to the determined signal power of the neighboring UE,
wherein the at least one adjusted transmission determination value includes the adjusted determined signal power of each UE from among the one or more neighboring UEs.

9. The first UE of claim 6, wherein the generating of the at least one adjusted transmission determination value comprises:
determining priorities of the one or more neighboring UEs; and
for each neighboring UE from among the one or more neighboring UEs, determining a multiplier value of the neighboring UE based on the determined priority of the neighboring UE, and
adjusting the determined signal power of the neighboring UE by multiplying the determined signal power of the neighboring UE by the determined multiplier value of the neighboring UE,
wherein the at least one adjusted transmission determination value includes the adjusted determined signal power of each UE from among the one or more neighboring UEs.

10. The first UE of claim 1, wherein the first UE is an out of coverage (OoC) UE.

11. The first UE of claim 1, wherein the first UE is an in coverage (InC) UE.

12. A method of operating a first user equipment (UE) of a wireless communications system, the method comprising:
receiving, at the first UE, first sidelink (SL) synchronization signaling from each of one or more neighboring UEs from among a plurality of neighboring UEs; and
determining, by the first UE, whether to transmit a second SL synchronization signaling, based on the received first SL synchronization signaling,
wherein the determining includes,
generating at least one adjusted transmission determination value by adjusting at least one of,
a synchronization transmission threshold, or
signal powers of the one or more neighboring UEs, and
determining whether to transmit the second SL synchronization signaling based on the adjusted transmission determination value.

13. The method of claim 12, further comprising:
determining a priority of the first UE.

14. The method of claim 13, wherein, for each of the one or more neighboring UEs, the first SL synchronization signaling received from the neighboring UE includes a SL synchronization signal block (S-SSB).

15. The method of claim 13, wherein the generating of the at least one adjusted transmission determination value comprises:
determining, based on the determined priority of the first UE, an offset value; and
adjusting the synchronization transmission threshold by adding the determined offset value to the synchronization transmission threshold,
wherein at least one adjusted transmission determination value includes the adjusted synchronization transmission threshold.

16. The method claim 13, wherein the generating of the at least one adjusted transmission determination value comprises:
determining, based on the priority of the first UE, a multiplier value; and
adjusting the synchronization transmission threshold by multiplying the synchronization transmission threshold by the determined multiplier value,
wherein at least one adjusted transmission determination value includes the adjusted synchronization transmission threshold.

17. The method of claim 13, further comprising:
determining the signal powers of the one or more neighboring UEs based on the first SL synchronization signaling.

18. The method of claim 17,
wherein, for each of the one or more neighboring UEs, the first SL synchronization signaling received from the neighboring UE includes an SL synchronization signal block (S-SSB), and
wherein, the determining of the signal powers of the one or more neighboring UEs includes, for each neighboring UE among the one or more neighboring UEs, measuring an SL reference signal received power (S-RSRP) of the UE based on the S-SSB received from the neighboring UE.

19. The method of claim 17, wherein the generating of the at least one adjusted transmission determination value comprises:
determining priorities of the one or more neighboring UEs; and
for each neighboring UE from among the one or more neighboring UEs,
determining an offset value of the neighboring UE based on the determined priority of the neighboring UE, and
adjusting the determined signal power of the neighboring UE by adding the determined offset value of the neighboring UE to the determined signal power of the neighboring UE,
wherein the at least one adjusted transmission determination value includes the adjusted determined signal power of each UE from among the one or more neighboring UEs.

20. (canceled)

21. (canceled)

22. (canceled)

23. A first user equipment (UE), of a wireless communications system, the UE comprising:
receiving means for receiving, at the first UE, first sidelink (SL) synchronization signaling from each of one or more neighboring UEs from among a plurality of neighboring UEs; and
first determining means for determining, by the first UE, whether to transmit a second SL synchronization signaling, based on the received first SL synchronization signaling, wherein the first determining includes,
generating means for generating at least one adjusted transmission determination value by adjusting at least one of,
a synchronization transmission threshold, or
signal powers of the one or more neighboring UEs, and
second determining means for determining whether to transmit the second SL synchronization signaling based on the adjusted transmission determination value.
